(19) United States
(12) Patent Application Publication
(10) Pub. No.: US 2012/0263825 A1
(43) Pub. Date: Oct. 18, 2012

(54) PROCESS FOR PRODUCING BAKED GOODS

(75) Inventors: Ralf Diener, Neustadt (DE); Jürgen Schneider, Bobenheim Am Berg (DE); Claudia Neumann-Liedemit, Neckargemund (DE); Madalina Andreea Stefan, Trostberg (DE); Frider Borgmeier, Mannheim (DE)

(73) Assignee: BASF SE, Ludwigshafen (DE)

(21) Appl. No.: 13/511,528

(22) PCT Filed: Nov. 19, 2010
(86) PCT No.: PCT/EP10/67814

§ 371 Date: May 23, 2012

(30) Foreign Application Priority Data
Nov. 25, 2009 (EP) 09177062.8

(51) Int. Cl. A21D 2/02; A21D 8/04; A21D 10/02; A23G 1/32; A21D 13/08; A23L 1/10; A23G 1/50; A21D 2/04; A21D 8/06

(52) U.S. Cl. 426/20; 426/551; 426/61; 426/496; 426/270

(57) ABSTRACT

The present invention relates to a process for producing baked goods which is characterized in that a mixture of at least one baking raising agent and at least one substance selected from the group consisting of asparaginase, sulfites, bisulfites, metabisulfites and chlorides is used in the production of the baked goods dough. In addition, the present invention relates to a mixture of at least one baking raising agent and at least one substance selected from the group consisting of asparaginase, sulfites, bisulfites, metabisulfites and chlorides. In addition, the present invention relates to the use of sulfites and metabisulfites for decreasing acrylamide in foods.

The present invention relates to a process for producing baked goods which is characterized in that a mixture of at least one baking raising agent and at least one substance selected from the group consisting of asparaginase, sulfites, bisulfites, metabisulfites and chlorides is used in the production of the baked goods dough. In addition, the present invention relates to a mixture of at least one baking raising agent and at least one substance selected from the group consisting of asparaginase, sulfites, bisulfites, metabisulfites and chlorides. In addition, the present invention relates to the use of sulfites and metabisulfites for decreasing acrylamide in foods.

Since time immemorial, carbohydrate-rich roods have played an important role in feeding the world population. Baked goods, such as for example, bread, rolls, crispbread, pretzels, cakes, honey cakes, gingerbread, spiced Spekulatius cookies, cookies, wafers, chocolate bars, crackers, salt sticks or the like are very popular in all parts of the world. Although these carbohydrate-rich foods have been making up an important component of the human diet for a long time, it has only been recently discovered that these foods contain acrylamide (J. Agric. Food Chem., 2002, 50, 4998-5006).

It is described that acrylamide is principally formed from the amino acid asparagine and reducing sugars such as glucose, preferentially at high temperatures and low water content.

Acrylamide has been described as carcinogenic. However, no clear correlation between acrylamide pollution in the human body and dietary behavior has been established, just as between acrylamide uptake and the probability of suffering cancer (Deutsches Ärzteblatt 102, edition 39, 09.30.2005, pages A-2640 ff.; American Chemical Society, Proceedings of the symposium, “Chemistry and Toxicology of Acrylamide”, 08.21.2007).

Despite the lack of scientific proof of a danger to health due to the consumption of acrylamide-containing foods, a Europe-wide program for decreasing the acrylamide content in foods has been started. The described signal values are for spiced Spekulatius cookies 416 μg/kg and for gingerbread 1000 μg/kg of acrylamide per kg of baked goods.

Since the first publication of the acrylamide content in foods, this topic has been intensely researched. At the forefront of the research was, firstly, lowering the amino acid asparagine, and secondly minimizing the acrylamide concentration.

It has been found that acrylamide is principally formed when cereal-containing foods are heated dry above 180° C. Acrylamide formation already starts at 120° C., but increases abruptly at 170-180° C. In many cases, the acrylamide formation can actually be reduced by lowering the temperature and/or by increased moisture. In addition, the acrylamide formation may be minimized by lowering the pH.

It is described that the asparagine content during the baking operation can be decreased, for example, by treating the wheat from which the flour is obtained with sulfate fertilizer. In addition, the acrylamide formation can be decreased by using tartaric or citric acid. Furthermore, a decrease can be achieved by lowering the sugar content or by replacing the invert sugar by cane sugar.

Unfortunately, many of the above possibilities for minimizing acrylamide formation cannot be achieved, owing to the existing recipes for baked goods.

It has been additionally established that the baking raising agent used has an effect on the acrylamide concentration. Baking raising agents are typically used in order to improve the consistency of baked goods. These baking raising agents, on the action of heat, release gaseous products which are intended to raise the dough.

Ammonium hydrogencarbonate, also known as ammonium bicarbonate, and hartshorn, which is composed of ammonium hydrogencarbonate and ammonium carbamate/ammonium carbonate, have been known for years as baking raising agents. During the baking operation (at about 60° C.) they decompose completely into the gaseous products ammonia, CO₂ and water, without leaving behind any residues that impair taste. Ammonium hydrogencarbonate is distinguished by a high raising power and has an advantageous effect on color, taste and consistency of the baked goods.

Further inorganic baking raising agents are potassium carbonate (potash) and sodium hydrogencarbonate (baking soda), which, however, should be combined with acid carriers such as Na₂H₂P₂O₇ or Ca(H₂P₂O₄)₂ and separating agents such as starch.

By replacing the classical baking raising agent ammonium hydrogencarbonate with alternative baking raising agents such as sodium bicarbonate or sodium hydrogencarbonate, although the acrylamide formation could be decreased, this replacement is associated with changes in taste and consistency of the baked goods. In addition, the baking lines frequently used in bakeries would have to be converted, since then in addition to the baking raising agent, an acidic activating agent and, in addition, a separating agent would have to be added.

Consequently, there is great interest from the bakeries in being able to continue to use ammonium hydrogencarbonate as baking raising agent and to minimize the formation of acrylamide in other ways.

WO 2004/32648 discloses that the formation of acrylamide during the heating of a mixture containing carbohydrates, proteins and water can be decreased when the mixture, before it is heated, is treated with an enzyme. It is described that the enzyme is added to the mixture by mixing or kneading. The enzyme can be added in the form of an aqueous solution, a powder, granules, or an agglomerated powder. As enzyme, asparaginase is advantageously used. Important fields of application mentioned are, inter alia, French fries, potato crisps, crispbread, muesli, etc.

WO 2004/26043 likewise discloses an addition of asparaginase to the mixture before it is heated for decreasing acrylamide formation. It is described that the enzyme asparaginase can be added to the mixture in the most varied form and at various processing stages. The enzyme can be used in the form of a powder or as a solution. The main fields of application mentioned are French fries, and also potato, corn or tortilla chips.

A disadvantage of the use of asparaginase is that production thereof is cost-intensive. Asparaginase, in addition, is not storage stable to the desired extent and, furthermore, a stable mixture of asparaginase with the other dough components may be achieved only with great expenditure.

Ou et al. disclose that NaHSO₃, CaCl₂ or L-cysteine lower the formation of acrylamide in the production of French fries. It is described that the French fries, before they were deep fried, were impregnated in a solution comprising NaHSO₃, CaCl₂ or L-cysteine.

The Institut für Lebensmittel- and Umweltforschung e.V. [Institute for Food and Environmental Research] discloses that the acrylamide content may be significantly decreased in baked goods by adding potassium chloride or sodium chloride. However, the required amount of potassium chloride or sodium chloride would impair the taste of the foods.

Said possibilities are costly for the use in the production of baked goods since they would mean a further addition or metering of the acrylamide-reducing additive.

There is therefore great interest in integrating the addition of an acrylamide-decreasing additive to the dough of a baked goods item into the process for producing these baked goods, without introducing a separate/further addition and therefore further process stages and without having to increase the complexity of the baking process.

A further addition would lead to increased risk of confusion in the process for producing baked goods. The metering and addition of the respective dough ingredients is customarily performed by untutored personnel, at best by a master baker. To a chemically unschooled eye, the acrylamide-decreasing substances, however, are very similar to the other dough components such as baking raising agents, flour, sugar or salt. There is therefore the fear that the rejection of baked goods produced would increase owing to the more complex baking operation.

The object of the present invention was accordingly to find a form of addition of the acrylamide-decreasing substance which does not increase the complexity of the process for producing baked goods, and in addition may be integrated into a baking line without modifying the process. In addition, the acrylamide-decreasing additives should be present homogeneously in the dough mixture before the dough is heated.

A further object of the present invention was to indicate alternative acrylamide-decreasing substances to asparaginase.

Surprisingly it has been found that a process for producing baked goods which is characterized in that a mixture of at least one baking raising agent and at least one substance selected from the group consisting of asparaginase, sulfites, bisulfites, metabisulfites and chlorides is used in the production of the baked goods dough is suitable for producing low-acrylamide baked goods without increasing the complexity of the baking process.

The term “baked goods” shall include any product made from dough, for example a product of soft or crispy consistency. Examples of baked goods of the white, light or dark type which can be expediently produced according to the invention are bread, rolls, crispbread, pretzels, cakes, honey cakes, gingerbread, spiced Spekulatius cookies, cookies, wafers, chocolate bars, crackers, salt sticks or the like.

Preferably, the present invention relates to the production of crispbread, gingerbread, spiced Spekulatius cookies, crackers, sesame sticks and chocolate bars.

On the use of this mixture of at least one baking raising agent and at least one substance selected from the group consisting of asparaginase, sulfites, bisulfites, metabisulfites and chlorides, bakers do not need to make any modifications to their baking process employed. Said mixture can be used in a similar manner to the conventionally used baking raising agent. The decrease in acrylamide formation achieved is comparable to the separate metering of the substance and baking raising agent.

The mixture of baking raising agent and substance selected from the group consisting of asparaginase, sulfites, bisulfites, metabisulfites and chlorides advantageously has, when asparaginase is used, a weight ratio of baking raising agent to asparaginase of 1000:1 to 1:200, preferably 200:1 to 1:100, particularly preferably from 100:1 to 1:50, in particular from 80:1 to 1:10, further preferably 20:1 to 2:1.

The asparaginase content in relation to the flour used in the dough is advantageously 0.5 to 200 g of asparaginase per 1 kg of flour, preferably 1 to 100 g of asparaginase per 1 kg of flour, in particular 1.5 to 30 g of asparaginase per 1 kg of flour. Typically, the asparaginase content in the flour is 1540 mg of asparagine per 1 kg of flour (J. Agric. Food. Chem 2003, 4504, or J. Sci. Food Agric 1979, 53).

The amount of asparaginase is frequently reported in what are termed asparaginase units (units); advantageously, 5000 to 1,500,000 units are added per 1 kg of flour, preferably 10,000 to 750,000, in particular 15,000 to 250,000 asparaginase units per 1 kg of flour.

The asparaginase enzyme can be of any desired origin, including of plant origin, preference is given to an asparaginase enzyme of microbial origin. The asparaginase enzyme is described, for example, in WO 2004/026043. The microbial asparaginase enzyme can originate, e.g. from bacteria, molds or yeasts.

The asparaginase can be obtained from the respective microorganism using any suitable art. For example, a formulation can be obtained by fermentation of a microorganism and subsequent isolation of an asparaginase-containing formulation form the resultant fermented broth or from the microorganism by processes known from the prior art. It is preferred to obtain the enzyme using DNA-recombination techniques known from the art. Such a process usually comprises culturing a host cell which has been transformed using a DNA recombination vector. The cell is able to express and carry a DNA sequence encoding the asparaginase in question. The cell can live in a culture medium under conditions under which the enzyme can be expressed and can be isolated from the culture. The DNA sequence can originate from genomes or c-DNA, or it can be of synthetic origin or originate from a mixture thereof. It can be isolated or synthesized by processes known from the art.

The asparaginase enzyme can be present in any form which makes it miscible with the baking raising agent. The enzyme can be present, e.g. in the form of a dry powder or granules, in particular dust-free granules, or as a protected enzyme. Granules can be produced by known processes and optionally can be coated by processes known from the art. Protected enzymes can be produced by the processes already disclosed in the literature.

Usually, for mixing the enzyme component with the inorganic baking raising agent, it is expedient that the enzyme preparation is present in the form of a dry product, e.g. dust-free granules.

The mixture of baking raising agent and substance selected from the group consisting of asparaginase, sulfites, bisulfites, metabisulfites and chlorides advantageously has, with the use of sulfites, bisulfites, metabisulfites and/or chlorides, a weight ratio of baking raising agent to sulfites, bisulfites, metabisulfites and/or chlorides from 200:1 to 1:10, preferably from 100:1 to 1:2, in particular 20:1 to 1:1.

Said sulfites, bisulfites, metabisulfites and chloride are commercially available.

Preferably, as acrylamide-decreasing substance, sodium, potassium and/or calcium chloride, alkali metal and/or alkaline earth metal sulfites, bisulfites and/or metabisulfites are used. Particularly preferably, alkali metal and/or alkaline earth metal sulfites, and/or metabisulfites are used. In particular, sodium and/or potassium sulfites and/or metabisulfites are used. Very particularly preferred are sodium sulfite and/or sodium metabisulfite.

The baking raising agent comprises at least one carbonate. As carbonate, use is made of carbonates the use of which is safe in foods and which, just like their decomposition products, do not lead to an unpleasant taste of the finished baked goods. Suitable carbonates which are present alone or in a mixture are known to those skilled in the art and typically, use is made of alkali metal carbonates and alkali metal hydrogencarbonates, in particular sodium carbonate, sodium hydrogencarbonate, potassium carbonate and potassium hydrogencarbonate and also ammonium carbonate and ammonium hydrogencarbonate. Equally suitable is the mixture of ammonium carbonate and ammonium hydrogen-carbonate customarily termed hartshorn, which additionally can also comprise ammonium carbamate.

Preferably, the carbonate is ammonium hydrogencarbonate and/or ammonium carbonate. Particular preference is given to the carbonate ammonium hydrogencarbonate (also called ammonium bicarbonate).

The median particle diameter of the carbonates used is generally 50 to 1000 μm, preferably 75 to 700 μm, more preferably 150 to 500 μm. The particle diameter of the substance selected from the group consisting of asparaginase, sulfites, bisulfites, metabisulfites and chlorides is advantageously selected such that a stable mixture with the baking raising agent or the respective baking raising agents results.

Optionally, the baking raising agent additionally comprises one or more carbamates. As carbamate, such a carbamate or such carbamates is or are selected, the use of which in foods is safe, and which, just like their decomposition products, do not lead to an unpleasant taste in the finished baked goods. A suitable carbamate is, for example, ammonium carbamate.

If the baking raising agent comprises carbamate, the amount of carbamate is preferably 10 to 90% by weight, based on the total amount of the baking raising agent, preferably 30 to 70% by weight, in particular approximately 50% by weight. The mixture of equal parts of ammonium carbamate and ammonium bicarbonate is also called ammonium carbonate.

If the baking raising agent used comprises components which, on heating to typical baking temperatures of for example 100 to 200° C., do not decompose or do not decompose sufficiently, the baking raising agent additionally comprises an acid or an acidifier. The acid or the acidifier is a compound or compound mixture known for this application, for example potassium tartrate, sodium tartrate, potassium hydrogen tartrate and/or calcium tartrate, citric acid, calcium hydrogenphosphate, sodium hydrogenpyrophosphate and/or sodium aluminum phosphate. If the baking raising agent comprises acid or acidifier, the amount of acid or acidifier is preferably as much as is required for converting the baking raising agent and therefore for release of carbon dioxide. Depending on acid strength, number of protons per molecule and molecular weight of the acid and of the baking raising agent, this amount can differ greatly. As an example, when sodium bicarbonate is used and for customary acid carriers, this gives a range of 60 to 250% by weight, based on the total amount of the baking raising agent, preferably 75 to 225% by weight.

If the baking raising agent comprises an acid or an acidifier, preferably a separating agent is also added thereto, which separating agent prevents premature carbon dioxide formation due to reaction of the carbonate with the acid or the acidifier. Such separating agents are known, preference is given to flour and/or starch.

The median particle diameters of the acids or acidifiers used are generally 50 to 1000 μm, preferably 75 to 700 μm, preferably 150 to 500 μm.

Said carbonates, carbamates, acids or acidifiers and also separating agents are commercially available.

The process for producing the baling raising agents has long been known to those skilled in the art. For example, ammonium compounds such as ammonium carbonate, ammonium bicarbonate and ammonium carbamate are produced by reacting the appropriate amounts of ammonia, typically 10 to 20%, and carbon dioxide added in excess, typically 30 to 65% in an aqueous mother liquor, at the appropriate pressure, typically 1 to 6 bar and temperature, typically 30 to 65° C., followed by crystallization, separation and drying of the precipitate.

A detailed description of the production of baking raising agents may be found, for example, in Ullmann's Encyclopedia of Industrial Chemistry, 2008 Edition.

The baking raising agent can in addition comprise one or more (further) enzymes. Examples of enzymes are cellulase, lactase, hemicellulase, pentosanase, glucoseoxidase (which is suitable for strengthening the dough), lipase (which is suitable for modifying lipids present in the dough in such a manner that the dough becomes soft), peroxidase (which is useful for improving dough consistency), protease (which is suitable for gluten weakness), peptidase and/or amylase, e.g. α-amylase (which is suitable for providing yeast-fermentable sugars).

The further enzyme components are preferably also of microbial origin and can, as mentioned above, be obtained by conventional processes. In one embodiment, the further enzyme components can be produced from the same source as the asparaginase in question and be obtained together with the asparaginase.

Apart from further enzyme components, the baking raising agent can also comprise other customarily used additives or aids, e.g. one or more of the following components: milk powder (which gives a desired crust color), gluten (for improving the gas retention power of low-gluten flour), an emulsifier (for improving the dough extensibility and the consistency of the resultant bread), fat granules (for dough softening and consistency softening of the bread), an oxidizing agent (for strengthening the gluten structure; e.g. ascorbic acid, potassium bromate, potassium iodate or ammonium persulfate), amino acids (e.g. cysteine), sugars and salts (e.g. sodium chloride, calcium acetate, sodium sulfate or calcium sulfate; for strengthening the dough).

Examples of suitable emulsifiers are mono- or diglycerides, diacetyl tartaric esters of mono- or diglycerides, sugar esters of fatty acids, polyglycerol esters of fatty acids, lactic esters of monoglycerides, acetic esters of monoglycerides, polyoxyethylene stearates, phospholipids and lecithin.

The mixture of at least one baking raising agent and at least one substance, which minimizes the formation of acrylamide is typically added in an amount of 0.1 to 5% by weight, based on the total resulting dough, preferably 0.5 to 2% by weight, in particular approximately 1% by weight.

The dough is typically composed of a starch source such as flour and/or potato starch, a protein source such as egg white, frequently fats such as butter, oil and/or margarine, and usually other ingredients such as sugar, salt, baking raising agent, spices, fruits or the like.

The basis of the dough and/or the baked goods produced is typically, e.g. a wheat flour or fine meal, optionally in combination with other flour or fine meal types, such as cornflour, rye flour, fine rye meal, oat flour or fine oatmeal, soy flour, millet flour or fine millet meal, potato flour or fine potato meal.

Customarily the amount of baking raising agent is chosen such that, per 100 g of the starch source used (e.g. flour and/or potato starch), advantageously 1.5 to 3.5 g of gases (carbon dioxide, ammonia and/or water vapor), preferably 2 to 3 g of gases, in particular 2.35 to 2.85 g of gases, are evolved.

If relatively non-porous baked goods are produced, the amount must be correspondingly lowered: and for relatively more porous baked goods, correspondingly increased.

In addition to the baking raising agent, other ingredients can be used which likewise lead to porosity in the baked goods produced, for example yeast and/or sourdough, likewise, the porosity can be increased by blowing gases such as air into the dough or by mixing in foamed or whipped components, such as egg white, for example.

In addition, the present invention relates to a mixture of at least one baking raising agent and at least one substance selected from the group consisting of asparaginase, sulfites, bisulfites, metabisulfites and chloride.

The general preferences with respect to the composition of the mixture correspond to the abovementioned.

As baking raising agent, preferably ammonium hydrogencarbonate and/or ammonium carbonate is used. Particular preference is given to ammonium hydrogencarbonate.

Preference is given to alkali metal and/or alkaline earth metal sulfites and/or metabisulfites. Particular preference is given to sodium and/or potassium sulfites and/or metabisulfites. Very particular preference is given to sodium sulfite and/or sodium metabisulfite.

The mixture of baking raising agent and sulfites and/or metabisulfites is advantageously in a weight ratio of baking raising agent to sulfites and/or metabisulfites of 200:1 to 1:10, preferably of 100:1 to 1:2, in particular 20:1 to 1:1.

In addition, the present invention relates to the use of a mixture of at least one baking raising agent and at least one substance selected from the group consisting of asparaginase, sulfites, bisulfites, metabisulfites and chloride in a process for producing baked goods.

The preferences with respect to the composition of the mixture correspond to the abovementioned.

In addition the present invention relates to the use of sulfites and/or metabisulfites for decreasing acrylamide in foods.

Advantageously, the sulfites and/or metabisulfites are added during production of the food. This can take place at all process stages known to those skilled in the art. Advantageously, the addition takes place before the food is heated.

The amount of the sulfites and/or metabisulfites which are added to the food is dependent on the food and is about 0.08 to 0.00001 kg per kg of food, preferably 0.02 to 0.00001, in particular 0.001 to 0.0001.

The advantage of the process according to the invention is that a substance minimizing the formation of acrylamide can be added to the baked goods dough without modifying the process for producing baked goods. Therefore, an increase in the complexity of the process for producing baked goods is avoided and the associated faulty batches due to confusion are excluded.

In addition, homogeneous distribution of this substance is ensured, since it is added together with the baking raising agent and therefore is subject to the same proven homogeneous mixing for the baking raising agent. If, nevertheless, non-homogeneous mixing occurs, baked goods having a nor-uniform porosity would be produced which are readily differentiated visually from the desired baked goods. Although such pastries would have very large single cavities, they would otherwise predominantly comprise regions having undesirably low porosity which makes the pastries hard and frequently also unattractive. If the large cavities occur on the surface of the pastries, in the baking process the then thin dough layer on the surface will finish baking substantially more rapidly and the baked goods in addition then exhibit an unattractive dark-brown to black coloration. Consequently, owing solely to the optical assessment of the baked goods without further analysis it is possible to establish whether a homogeneous distribution was achieved.

In addition, since, inter alia, the baking raising agents promote the formation of acrylamide, the efficacy of the substance which minimizes this formation can be utilized optimally by the joint addition to the baked goods dough together with the baking raising agent.

### EXAMPLES

1. Raw materials for the base doughs 1 and 2 which differ only in the wheat flour batch:

1.0 kg of wheat flour (405)

0.5 kg of sucrose (crystal sugar)

0.3 kg of water

2. Procedure:

Sugar was dissolved in water and processed with flour to give a homogeneous base dough. The additives (see the table) were made up with a sparing amount of water and added to the respective dough portions and again kneaded by hand for approximately 20 min. After addition of the additives, the dough was charged into aluminum pans in order to allow the dough to prove for 22 h at 40° C. Thereafter, the dough was baked for 30 min. at 200° C. The acrylamide content was measured on the basis of GC-MS analysis. The limit of detection of acrylamide is 30 μg/kg of dough.

3. Results:

TABLE 1
Wheat flour, Batch 1

| | Acrylamide formation |
|---|---|
| Additives | [μg/kg of dough] |
| 1% by weight of ABC | 270 |
| 1% by weight of ABC, | 95 |
| 0.5% by weight of | |
| NaHSO₃ | |
| 1% by weight of ABC, | 106 |
| 0.5% by weight of | |
| CaCl₂ | |
| 1% by weight of ABC, | <30 |
| 61 μl of asparaginase | |

TABLE 2
Wheat flour, Batch 2

| | Acrylamide formation |
|---|---|
| Additives | [μg/kg of dough] |
| 1% by weight of ABC | 48 |
| 1% by weight of ABC, | <30 |
| 0.5% by weight of | |
| Na₂S₂O₅ | |
| 1% by weight of ABC, | <30 |
| 0.1% by weight of | |
| Na₂S₂O₅ | |
| 1% by weight of ABC, | <30 |
| 0.05% by weight of | |
| Na₂S₂O₅ | |
| 1% by weight of ABC, | <30 |
| 0.1% by weight of | |
| Na₂SO₃ | |

1-12. (canceled)

13. A process for producing baked goods which comprises mixing at least one baking raising agent and at least one substance selected from the group consisting of asparaginase, sulfites, bisulfites, metabisulfites and chlorides in the production of the baked goods dough.

14. The process according to claim 13, wherein the mixture contains asparaginase, and has a weight ratio of baking raising agent to asparaginase in the range from 1000:1 to 1:200.

15. The process according to claim 13, wherein the mixture contains sulfites, bisulfites, metabisulfites or chlorides or a mixture thereof and has a weight ratio of baking raising agent to sulfites, bisulfites, metabisulfites and/or chlorides in the range from 200:1 to 1:10.

16. The process according to claim 13, wherein the mixture is used in an amount of 0.1 to 5% by weight, based on the total produced baked goods dough.

17. The process according to claim 13, wherein a mixture of at least one baking raising agent and at least one substance selected from the group consisting of sulfites, bisulfites and metabisulfites is used.

18. The process according to claim 13, wherein a mixture of at least one baking raising agent and sodium sulfite and/or sodium metabisulfite is used.

19. The process according to claim 17, wherein the mixture of baking raising agent and sodium sulfite and/or sodium metabisulfite has a weight ratio of baking raising agent to sodium sulfite and/or sodium metabisulfite in the range from 20:1 to 1:1.

20. The process according to claim 13, wherein the baking raising agent used is ammonium bicarbonate.

21. The process according to claim 13, wherein the baked goods produced are crispbread, gingerbread, spiced Spekulatius cookies, crackers, sesame sticks and/or chocolate bars.

22. A mixture of at least one baking raising agent and at least one substance selected from the group consisting of asparaginase, sulfites, bisulfites, metabisulfites and chloride.

23. The mixture according to claim 22, wherein the baking raising agent used is ammonium hydrogencarbonate and the substance is selected from the group consisting of sodium and/or potassium sulfites and/or metabisulfites, wherein the mixture has a weight ratio of baking raising agent to sodium and/or potassium sulfites and/or metabisulfites in the range from 20:1 to 1:1.

24. A baking process which comprises utilizing the mixture as claimed in claim 22.

25. A process for decreasing acrylamide in foods which comprises utilizing sulfites and/or metabisulfites.
